(19) United States
(12) Patent Application Publication
(10) Pub. No.: US 2025/0068995 A1
(43) Pub. Date: Feb. 27, 2025

(54) VEHICLE OPERATION MANAGEMENT DEVICE, VEHICLE OPERATION MANAGEMENT SYSTEM, COMPUTER READABLE STORAGE MEDIUM, AND VEHICLE OPERATION MANAGEMENT METHOD

(71) Applicant: Mitsubishi Electric Corporation, Tokyo (JP)

(72) Inventors: Takahisa AOYAGI, Tokyo (JP); Yusuke FUJIGAYA, Tokyo (JP); Sayuri FUKANO, Tokyo (JP); Kyosuke ISHII, Tokyo (JP); Keisuke MORITA, Tokyo (JP)

(73) Assignee: Mitsubishi Electric Corporation, Tokyo (JP)

(21) Appl. No.: 18/683,709

(22) PCT Filed: Sep. 15, 2021
(86) PCT No.: PCT/JP2021/033931

§ 371 Date: Feb. 14, 2024

(51) Int. Cl. G06Q 10/0631; B60L 58/12; B60W 60/00; G06Q 10/20; G06Q 50/47; G07C 5/00; G07C 5/08; G08G 1/14

(52) U.S. Cl. CPC G06Q 10/06311; B60L 58/12; B60W 60/00253; G06Q 10/20; G06Q 50/47; G07C 5/006; G07C 5/0816; G08G 1/141; B60L 2260/32; B60W 2510/244

(57) ABSTRACT

A vehicle operation management device (3) manages operation of a vehicle (2). The vehicle operation management device (3) includes an operation plan creation unit (31) that creates an operation plan of the vehicle (2) on the basis of a schedule for getting in and out of the vehicle (2) of a user who wants to ride the vehicle (2), and a travel instruction unit (34) that instructs the vehicle (2) to travel according to the operation plan.

When the user of the vehicle (2) is scheduled to get in the same vehicle (2) again after getting out of the vehicle (2), the operation plan creation unit (31) proposes, to the user, operation details of the vehicle (2) during a period of time from when the user gets out of the vehicle (2) to when the user gets in the vehicle (2) next, and creates the operation plan including the operation details proposed.

### FIELD

The present disclosure relates to a vehicle operation management device, a vehicle operation management system, a vehicle operation management program, and a vehicle operation management method for managing operation of a vehicle.

### BACKGROUND

A vehicle operation service that causes a vehicle carrying a user to travel to a point of destination by automated driving is known. Patent Literature 1 discloses a system that causes a vehicle to head to a location where a user waits and causes the vehicle carrying the user to travel to a point of destination by automated driving.

### CITATION LIST

### Patent Literature

Patent Literature 1: Japanese Patent Application Laid-open No. 2020-98610

### SUMMARY OF INVENTION

### Problem to be solved by the Invention

When a user uses a vehicle, the user may temporarily get out of the vehicle at a point of transit between a first point of departure and a final point of destination, and then get in the vehicle again to head to the next point of transit or the final point of destination. In this case, it may be convenient for the user to be able to use the same vehicle from the first point of departure to the final point of destination. When the user uses the same vehicle from the first point of departure to the final point of destination, an idle time occurs after the user gets out of the vehicle until he/she gets in the vehicle again. In a conventional technique that causes a vehicle carrying a user to travel to a point of destination, such an idle time is a period of time for the vehicle to just wait until the user gets in the vehicle again. It is thus desired to be able to efficiently utilize the idle time during which the user is not in the vehicle.

The present disclosure has been made in view of the above, and an object of the present disclosure is to provide a vehicle operation management device capable of efficiently utilizing an idle time during which a user is not in a vehicle.

### Means to Solve the Problem

In order to solve the above problem and achieve the object, a vehicle operation management device according to the present disclosure is a vehicle operation management device that manages operation of a vehicle. The vehicle operation management device according to the present disclosure includes an operation plan creation unit that creates an operation plan of the vehicle on the basis of a schedule for getting in and out of the vehicle of a user who wants to ride the vehicle, and a travel instruction unit that instructs the vehicle to travel according to the operation plan. When the user of the vehicle is scheduled to get in the same vehicle again after getting out of the vehicle, the operation plan creation unit proposes, to the user, operation details of the vehicle during the period of time from when the user gets out of the vehicle to when the user gets in the vehicle next, and creates the operation plan including the operation details proposed.

### Effects of the Invention

The vehicle operation management device according to the present disclosure has an effect of being capable of efficiently utilizing the idle time during which the user is not in the vehicle.

### BRIEF DESCRIPTION OF DRAWINGS

FIG. 1 is a diagram illustrating an example of a configuration of a vehicle operation management system including a vehicle operation management device according to a first embodiment.

FIG. 2 is a diagram illustrating functional configurations of a vehicle, the vehicle operation management device, and a mobile terminal in the first embodiment.

FIG. 3 is a first chart diagram illustrating an example of operations of the vehicle, the vehicle operation management device, and the mobile terminal in the first embodiment.

FIG. 4 is a second chart diagram illustrating an example of operations of the vehicle, the vehicle operation management device, and the mobile terminal in the first embodiment.

FIG. 5 is a chart diagram illustrating an example of operations of the vehicle, the vehicle operation management device, and the mobile terminal in a second embodiment.

FIG. 6 is a diagram illustrating an example of a hardware configuration of the vehicle operation management device according to the first and second embodiments.

FIG. 7 is a diagram illustrating an example of a hardware configuration of the mobile terminal according to the first and second embodiments.

### DESCRIPTION OF EMBODIMENTS

Hereinafter, a vehicle operation management device, a vehicle operation management system, a vehicle operation management program, and a vehicle operation management method according to embodiments will be described in detail with reference to the drawings.

### First Embodiment

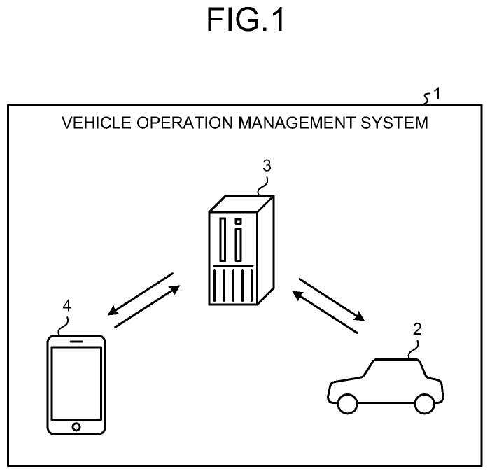

FIG. 1 is a diagram illustrating an example of a configuration of a vehicle operation management system 1 including a vehicle operation management device 3 according to a first embodiment. The vehicle operation management system 1 includes a vehicle 2 that travels while carrying a user, the vehicle operation management device 3 that manages operation of the vehicle 2, and a mobile terminal 4. The vehicle 2 and the vehicle operation management device 3 are communicably connected to each other via a network. The vehicle operation management device 3 and the mobile terminal 4 are communicably connected to each other via a network. In FIG. 1, transmission and reception of information between the vehicle 2 and the vehicle operation management device 3 and transmission and reception of information between the vehicle operation management device 3 and the mobile terminal 4 are indicated by arrows.

The vehicle 2 is, for example, a passenger car including an automated driving function. The vehicle 2 is used for a mobility service that sends a user from a point of departure to a point of destination according to the mobility needs of each user. The user is a person who gets in the vehicle 2 to receive the mobility service. The vehicle 2 performs automated driving according to a travel instruction sent from the vehicle operation management device 3. The vehicle 2 may be switchable between automated driving and manual driving by the user in the vehicle 2. Note that the vehicle 2 may have any configuration as long as the vehicle 2 travels while carrying the user. The vehicle 2 is connected to the network via wireless communication. The vehicle 2 receives the travel instruction sent from the vehicle operation management device 3. The vehicle 2 also transmits information related to a state of the vehicle 2 to the vehicle operation management device 3.

The vehicle operation management device 3 is installed, for example, at a base of an operator of the mobility service. The vehicle operation management device 3 is connected to the network to communicate with the vehicle 2 and the mobile terminal 4. The vehicle operation management device 3 communicates with each of a plurality of the vehicles 2 to manage operation of each of the vehicles 2. FIG. 1 illustrates one of the plurality of the vehicles 2 to be managed. The vehicle operation management device 3 accepts a request for use of the vehicle 2 by the user, and creates an operation plan of the vehicle 2. The vehicle operation management device 3 transmits the travel instruction according to the operation plan to the vehicle 2. The vehicle operation management device 3 also receives the information related to the state of the vehicle 2 from the vehicle 2.

The mobile terminal 4 is an example of an information processing terminal operated by the user and is, for example, a smartphone. The mobile terminal 4 may be a tablet terminal, a personal computer, or the like. The mobile terminal 4 is connected to the network via wireless communication. The mobile terminal 4 accepts a request for use of the vehicle 2 while an application or a browser for using the mobility service is activated. The mobile terminal 4 receives information such as a time slot for which the use of the vehicle 2 is desired, a point of departure, and a point of destination by an operation of the user. The mobile terminal 4 transmits the information input by the user to the vehicle operation management device 3. The mobile terminal 4 also receives a notification or the like sent from the vehicle operation management device 3. Note that the information processing terminal that accepts the request for the use of the vehicle 2 is not limited to the mobile terminal 4, and may be a stationary terminal. The person who requests the use of the vehicle 2 may be a person other than the user who uses the vehicle 2. Hereinafter, a description will be given assuming that the user who uses the vehicle 2 requests the use of the vehicle 2.

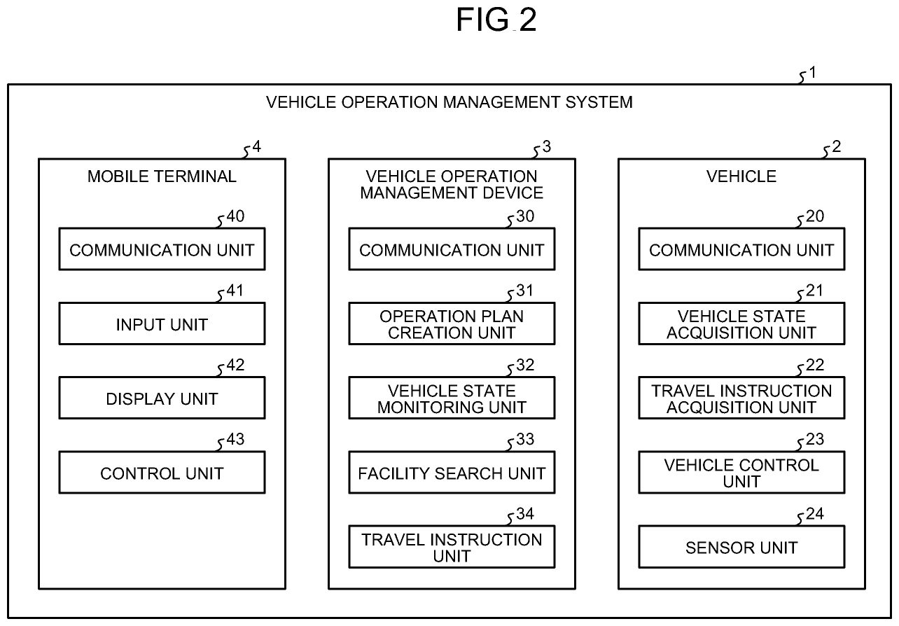

FIG. 2 is a diagram illustrating functional configurations of the vehicle 2, the vehicle operation management device 3, and the mobile terminal 4 in the first embodiment. The vehicle 2 includes a communication unit 20 that performs wireless communication with a device outside the vehicle 2, a vehicle state acquisition unit 21 that acquires the information related to the state of the vehicle 2, a travel instruction acquisition unit 22 that acquires the travel instruction, a vehicle control unit 23 that is a vehicle controller installed in the vehicle 2, and a sensor unit 24 that detects location information of the vehicle 2 or an obstacle around the vehicle 2. The communication unit 20 can perform the wireless communication using any communication system such as the fourth generation mobile communication system (4G) or fifth generation mobile communication system (5G).

In the vehicle 2, for each part of the vehicle 2, processing circuitry in which a self diagnosis function is programmed is incorporated. The vehicle state acquisition unit 21 acquires the information related to the state of the vehicle 2 by, for example, acquiring information indicating a result of self diagnosis from the processing circuitry of each part of the vehicle 2. Transfer of information within the vehicle 2 uses a communication protocol such as a controller area network (CAN). The information related to the state of the vehicle 2 includes information on a remaining battery level. The information related to the state of the vehicle 2 also includes information about a state of each part of the vehicle 2 such as an air pressure of a tire, an amount of wear of a tire, or a degree of soiling of a vehicle body.

In addition, the vehicle state acquisition unit 21 acquires information indicating a current location of the vehicle 2 from the sensor unit 24. Hereinafter, the information related to the state of the vehicle 2 is referred to as state information, and the information indicating the current location of the vehicle 2 is referred to as current location information. The vehicle state acquisition unit 21 transfers the state information and the current location information to the communication unit 20. The communication unit 20 transmits the state information and the current location information to the vehicle operation management device 3.

The communication unit 20 receives the travel instruction sent from the vehicle operation management device 3. The received travel instruction is transferred to the travel instruction acquisition unit 22. The travel instruction acquisition unit 22 thus acquires the travel instruction. The travel instruction includes information on a point of departure and a point of destination, and information on a travel route.

The sensor unit 24 includes means of acquiring the current location information and means of detecting an object around the vehicle 2. The means of acquiring the current location information is a satellite positioning system such as a global positioning system (GPS). The means of detecting an object includes, for example, a camera, a radar, or light detection and ranging (LiDAR). The means of detecting an object includes a device that performs object recognition on the basis of an output of the camera, radar, or LiDAR. The means of detecting an object performs object recognition to determine the type of the object such as a vehicle, a pedestrian, and an obstacle. The means of detecting an object acquires information about a location of the object, the type of the object, and a speed of movement of the object. Hereinafter, the information acquired by the means of detecting an object is referred to as object information. The current location information is transferred from the sensor unit 24 to the vehicle state acquisition unit 21 and the vehicle control unit 23. The object information is transferred from the sensor unit 24 to the vehicle control unit 23. Note that the means of acquiring the current location information may acquire image information by photographing with a camera and acquire the current location information on the basis of the image information.

The vehicle control unit 23 analyzes the content of the travel instruction acquired by the travel instruction acquisition unit 22. On the basis of the content of the travel instruction, the current location information, and the object information, the vehicle control unit 23 controls a direction of travel of the vehicle 2 and the speed of the vehicle 2. The vehicle control unit 23 thus controls travel of the vehicle 2. Note that the vehicle control unit 23 may control not only the travel of the vehicle 2 but also the entirety of the vehicle 2.

The vehicle operation management device 3 includes a communication unit 30 that communicates with a device outside the vehicle operation management device 3, an operation plan creation unit 31 that creates the operation plan, a vehicle state monitoring unit 32 that monitors the state of the vehicle 2, a facility search unit 33 that searches for a facility, and a travel instruction unit 34 that instructs the vehicle 2 to travel.

The communication unit 30 receives schedule information from the mobile terminal 4. The schedule information is information indicating a schedule for getting in and out of the vehicle 2 of the user who wants to ride the vehicle 2. The received schedule information is transferred to the operation plan creation unit 31. The operation plan creation unit 31 creates the operation plan of the vehicle 2 on the basis of the schedule information. Information of the operation plan created is transferred to the travel instruction unit 34.

The communication unit 30 receives the state information and the current location information from the vehicle 2. The received state information is transferred to the vehicle state monitoring unit 32. The vehicle state monitoring unit 32 monitors the state of the vehicle 2 on the basis of the state information, and outputs monitored state information indicating a result of monitoring. The vehicle state monitoring unit 32 monitors the remaining battery level of the vehicle 2 on the basis of the state information, and determines whether or not charging is necessary on the basis of the remaining battery level. The vehicle state monitoring unit 32 outputs the monitored state information indicating a result of determination as to whether or not charging is necessary. In addition, the vehicle state monitoring unit 32 monitors the state of each part of the vehicle 2 such as the air pressure of the tire, the amount of wear of the tire, or the degree of soiling of the vehicle body on the basis of the state information, and determines whether or not maintenance is necessary on the basis of the state of each part of the vehicle 2. The vehicle state monitoring unit 32 outputs the monitored state information indicating a result of determination as to whether or not maintenance is necessary. The monitored state information is transferred to the operation plan creation unit 31.

When the user of the vehicle 2 is scheduled to get in the same vehicle 2 again after getting out of the vehicle 2, the operation plan creation unit 31 proposes, to the user, operation details of the vehicle 2 during an idle time that is a period of time during which the user is not in the vehicle 2. The operation plan creation unit 31 proposes, to the user, the operation details of the vehicle 2 during the idle time from when the user gets out of the vehicle until when the user gets in the vehicle next. When the user approves the operation details proposed, the operation plan creation unit 31 creates the operation plan including the operation details proposed.

The operation plan creation unit 31 proposes the operation details created on the basis of the monitored state information to the user. Upon acquiring the monitored state information indicating that charging is necessary, the operation plan creation unit 31 creates the operation details including charging of the vehicle 2 on the basis of the monitored state information indicating that charging is necessary. Information of the operation details is transferred to the communication unit 30. The communication unit 30 transmits the information of the operation details to the mobile terminal 4. The operation plan creation unit 31 thus proposes the operation details including charging of the vehicle 2 to the user on the basis of the monitored state information indicating that charging is necessary. When the user approves the operation details including charging of the vehicle 2, the operation plan creation unit 31 creates the operation plan including travel from a drop-off location to a spot where charging is performed and travel from the spot where charging is performed to the next pick-up location. Hereinafter, the spot where charging is performed is referred to as a charging spot.

Upon acquiring the monitored state information indicating that maintenance is necessary, the operation plan creation unit 31 creates the operation details including maintenance of the vehicle 2 on the basis of the monitored state information indicating that maintenance is necessary. Information of the operation details is transferred to the communication unit 30. The communication unit 30 transmits the information of the operation details to the mobile terminal 4. The operation plan creation unit 31 thus proposes the operation details including maintenance of the vehicle 2 to the user on the basis of the monitored state information indicating that maintenance is necessary. When the user approves the operation details including maintenance of the vehicle 2, the operation plan creation unit 31 creates the operation plan including travel from a drop-off location to a spot where maintenance is performed and travel from the spot where maintenance is performed to the next pick-up location. Hereinafter, the spot where maintenance is performed is referred to as a maintenance spot. The maintenance spot is, for example, a dealer or a repair shop.

The operation plan creation unit 31 calculates, on the basis of the schedule information, the idle time from when the user gets out of the vehicle until when the user gets in the vehicle next. The operation plan creation unit 31 proposes the operation details that can be performed within the calculated idle time to the user. Specifically, when acquiring the monitored state information indicating that charging is necessary, the operation plan creation unit 31 creates the operation details such that a sum of a travel time from the drop-off location to the charging spot, the time required for charging, and a travel time from the charging spot to the next pick-up location is less than or equal to the idle time. Also, when acquiring the monitored state information indicating that maintenance is necessary, the operation plan creation unit 31 creates the operation details such that a sum of a travel time from the drop-off location to the maintenance spot, the time required for maintenance, and a travel time from the maintenance spot to the next pick-up location is less than or equal to the idle time. Thus, the vehicle operation management device 3 can propose the operation details that do not hinder the use of the vehicle 2 by the user.

The facility search unit 33 searches for a facility in the vicinity of the drop-off location or the pick-up location. In the first embodiment, the facility that the facility search unit 33 searches for is the charging spot or the maintenance spot. When acquiring the monitored state information indicating that charging is necessary, the operation plan creation unit 31 instructs the facility search unit 33 to search for the charging spot. When acquiring the monitored state information indicating that maintenance is necessary, the operation plan creation unit 31 instructs the facility search unit 33 to search for the maintenance spot. The facility search unit 33 returns a search result for the charging spot or the maintenance spot to the operation plan creation unit 31. The operation plan creation unit 31 creates the operation details including charging at the charging spot indicated in the search result, or the operation details including maintenance at the maintenance spot indicated in the search result.

The facility search unit 33 may acquire information indicating availability of the charging spot or maintenance spot found by the search, and send the information indicating the availability together with the search result to the operation plan creation unit 31. In this case, the operation plan creation unit 31 can create the operation details by confirming in advance that the charging spot or maintenance spot is available. The operation plan creation unit 31 may reserve the charging spot when approval for the operation details including charging is obtained. The operation plan creation unit 31 may reserve the maintenance spot when approval for the operation details including maintenance is obtained.

The travel instruction unit 34 acquires the information of the operation plan and creates the travel instruction according to the operation plan. The created travel instruction is transferred to the communication unit 30. The communication unit 30 transmits the travel instruction to the vehicle 2. The travel instruction unit 34 creates and outputs the travel instruction according to the operation plan, thereby instructing the vehicle 2 to travel according to the operation plan.

The mobile terminal 4 includes a communication unit 40 that performs wireless communication with a device outside the mobile terminal 4, an input unit 41 that receives information, a display unit 42 that displays information, and a control unit 43 that controls the mobile terminal 4 and performs various types of processing. The communication unit 40 can perform the wireless communication using any communication system such as 4G, 5G, or Wi-Fi (registered trademark).

During a state where the application or browser for using the mobility service is activated, the display unit 42 displays an input screen that accepts a reservation for the use of the vehicle 2. The user operates the input unit 41 in accordance with the input screen to input desired use details such as a date and time for using the vehicle 2, the pick-up location, and the drop-off location. The control unit 43 creates the schedule information in which the input use details are put together. The communication unit 40 transmits the schedule information to the vehicle operation management device 3.

When the user of the vehicle 2 is scheduled to get in the same vehicle 2 again after getting out of the vehicle 2, and the operation plan creation unit 31 proposes the operation details including charging or maintenance of the vehicle 2, the communication unit 40 receives the information of the operation details including charging or maintenance of the vehicle 2 from the vehicle operation management device 3. The display unit 42 displays the proposed operation details and a message requesting the user to select whether or not to approve the proposed operation details. When a response as to whether or not to approve the operation details is input to the input unit 41 by the user, the communication unit 40 transmits the input response to the vehicle operation management device 3.

As a case where the user uses the vehicle 2, the user may temporarily get out of the vehicle 2 at a point of transit between a first point of departure and a final point of destination, and then get in the vehicle again to head to the next point of transit or the final point of destination. The user may also rent the same vehicle 2 for a long period of time and get in and out of the vehicle 2 repeatedly. In such a case, it is convenient for the user to be able to continuously use the same vehicle 2. For example, the user can get out of the vehicle 2 with baggage left in the vehicle 2 and get around light. The user may use the vehicle 2 like this when going around multiple sights in a tourist area, for example. When the user uses the same vehicle 2 continuously, the idle time occurs after the user gets out of the vehicle until he/she gets in the vehicle again.

In the first embodiment, when the user of the vehicle 2 is scheduled to get in the same vehicle 2 again after getting out of the vehicle 2, the vehicle operation management device 3 proposes the operation details created on the basis of the monitored state information to the user. When the user approves the operation details proposed, the vehicle operation management device 3 creates the operation plan including the operation details proposed. The vehicle operation management device 3 can efficiently utilize the idle time by causing the vehicle 2 to travel according to the operation plan. The vehicle operation management device 3 allows necessary charging or necessary maintenance to be finished during the idle time without separately securing a time for charging or maintenance of the vehicle 2.

Next, operations of the vehicle 2, the vehicle operation management device 3, and the mobile terminal 4 will be described. Here, an example where the operation details including charging are proposed and an example where the operation details including maintenance are proposed will be described separately.

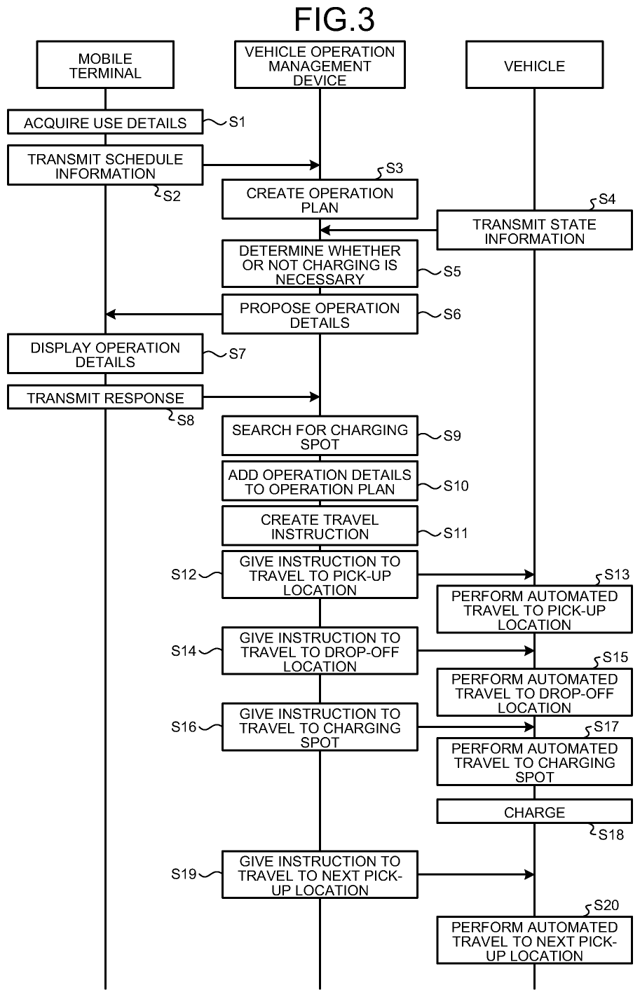

FIG. 3 is a first chart diagram illustrating an example of the operations of the vehicle 2, the vehicle operation management device 3, and the mobile terminal 4 in the first embodiment. The first chart diagram illustrates an operation procedure of the vehicle 2, the vehicle operation management device 3, and the mobile terminal 4 when the vehicle state monitoring unit 32 determines that charging of the vehicle 2 is necessary and the operation plan creation unit 31 proposes the operation details including charging.

The user inputs information of desired pick-up location and pick-up time and desired drop-off location and drop-off time to the mobile terminal 4. As a result, in step S1, the mobile terminal 4 acquires the use details desired by the user. The mobile terminal 4 creates the schedule information in which the acquired use details are put together. In step S2, the mobile terminal 4 transmits the schedule information to the vehicle operation management device 3. The schedule information transmitted to the vehicle operation management device 3 may be information about getting in/out of the vehicle one time or information about getting in/out of the vehicle multiple times. Getting in/out of the vehicle multiple times may be getting in/out of the vehicle multiple times on a certain day or getting in/out of the vehicle multiple times over multiple days. The vehicle operation management device 3 is on standby to receive the schedule information. Upon receiving the schedule information from the mobile terminal 4, the vehicle operation management device 3 stores the schedule information received.

The mobile terminal 4 accepts, as needed, a change or cancellation of the schedule information stored in the vehicle operation management device 3. When the user gives an instruction to change or cancel the schedule information, the mobile terminal 4 transmits an instruction to change or cancel the schedule information to the vehicle operation management device 3. The vehicle operation management device 3 receives the instruction to change or cancel the schedule information and changes or deletes the schedule information according to the instruction.

In step S3, the vehicle operation management device 3 creates the operation plan on the basis of the schedule information received. When creating the operation plan, the vehicle operation management device 3 requests the vehicle 2 to transmit the state information. In step S4, the vehicle 2 transmits the state information to the vehicle operation management device 3. The vehicle operation management device 3 acquires the state information by receiving the state information transmitted from the vehicle 2. Here, the vehicle operation management device 3 acquires the state information at a timing when creating the operation plan, but the present disclosure is not limited thereto. The vehicle operation management device 3 may periodically acquire the state information, for example. The vehicle 2 may transmit the state information at a predetermined timing instead of transmitting the state information in accordance with the request from the vehicle operation management device 3.

When creating the operation plan, the vehicle operation management device 3 determines whether or not the user of the vehicle 2 is scheduled to get in the same vehicle 2 again after getting out of the vehicle 2. The drop-off location and the next pick-up location may be the same location or different locations. Here, it is assumed that the user is scheduled to get in the same vehicle 2 again after getting out of the vehicle 2. Note that, when the user is not scheduled to get in the same vehicle 2 again after getting out of the vehicle 2, the vehicle operation management device 3 does not perform operations in and after step S5, and creates the travel instruction according to the operation plan created.

In step S5, the vehicle operation management device 3 determines whether or not charging of the vehicle 2 is necessary on the basis of the state information.

Here, it is assumed that the vehicle operation management device 3 determines that charging is necessary. The vehicle operation management device 3 creates the operation details for charging the vehicle 2 during the idle time when the user is not in the vehicle. In step S6, the vehicle operation management device 3 proposes the created operation details to the user. The vehicle operation management device 3 proposes the operation details to the user by transmitting the information of the operation details to the mobile terminal 4. When the mobile terminal 4 receives the information of the operation details, in step S7, the mobile terminal 4 displays the operation details proposed by the vehicle operation management device 3.

The user inputs a response as to whether or not to approve the proposed operation details to the mobile terminal 4. When the response is input to the mobile terminal 4, in step S8, the mobile terminal 4 transmits the response to the vehicle operation management device 3. Here, it is assumed that the user approves the operation details. Note that, if the user does not approve the operation details, the vehicle operation management device 3 transmits a message requesting a change or cancellation of the schedule information to the mobile terminal 4. The mobile terminal 4 displays the message requesting a change or cancellation of the schedule information, and accepts a change or cancellation of the schedule information.

In step S9, the vehicle operation management device 3 searches for a charging spot. The vehicle operation management device 3 searches for a charging spot around the drop-off location or the next pick-up location, and determines the charging spot for charging the vehicle 2. In step S10, the vehicle operation management device 3 adds, to the operation plan, the operation details including travel from the drop-off location to the charging spot and travel from the charging spot to the next pick-up location. The vehicle operation management device 3 thus creates the operation plan including charging of the vehicle 2. The above steps S1 to S10 are the operation procedure when the user reserves the use of the vehicle 2. Note that, when the vehicle operation management device 3 determines that charging is unnecessary in step S5, the vehicle operation management device 3 does not perform the operations in steps S6 to S10, and creates the operation plan not including charging of the vehicle 2.

The following steps S11 to S20 are the operation procedure when the vehicle 2 travels in accordance with the operation plan. In step S11, the vehicle operation management device 3 creates the travel instruction for causing the vehicle 2 to travel according to the operation plan. In step S12, the vehicle operation management device 3 instructs the vehicle 2 to travel to the pick-up location that is the location where the user gets in the vehicle 2. The vehicle operation management device 3 instructs the vehicle 2 to travel to the pick-up location by transmitting the travel instruction to the vehicle 2. When the vehicle 2 receives the travel instruction, in step S13, the vehicle 2 performs automated travel to the pick-up location according to the travel instruction. The vehicle operation management device 3 checks a traveling status of the vehicle 2 as needed on the basis of the current location information transmitted from the vehicle 2. The vehicle operation management device 3 collates the traveling status of the vehicle 2 with the operation plan, and controls travel of the vehicle 2 such that the vehicle 2 travels according to the operation plan. The vehicle operation management device 3 checks a traffic congestion status of a route on which the vehicle is scheduled to travel, and changes the travel route as necessary.

Upon confirming that the vehicle 2 has arrived at the pick-up location, the vehicle operation management device 3 sends a message indicating the arrival of the vehicle 2 to the mobile terminal 4 to notify the user that the vehicle 2 has arrived. After that, upon confirming that the user has got in the vehicle 2 at the pick-up location, in step S14, the vehicle operation management device 3 instructs the vehicle 2 to travel to the drop-off location that is the location where the user gets out of the vehicle 2. The vehicle operation management device 3 instructs the vehicle 2 to travel to the drop-off location by transmitting the travel instruction to the vehicle 2. When the vehicle 2 receives the travel instruction, in step S15, the vehicle 2 performs automated travel to the drop-off location according to the travel instruction.

When the vehicle operation management device 3 confirms that the vehicle 2 has arrived at the drop-off location and that the user has gotten out of the vehicle 2, in step S16, the vehicle operation management device 3 instructs the vehicle 2 to travel to the charging spot. The vehicle operation management device 3 instructs the vehicle 2 to travel to the charging spot by transmitting the travel instruction to the vehicle 2. When the vehicle 2 receives the travel instruction, in step S17, the vehicle 2 performs automated travel to the charging spot according to the travel instruction. When the vehicle 2 arrives at the charging spot, in step S18, the vehicle 2 is charged.

The vehicle operation management device 3 confirms that charging of the vehicle 2 at the charging spot is completed on the basis of the current location information transmitted from the vehicle 2 and the state information transmitted from the vehicle 2. When the vehicle operation management device 3 confirms that charging of the vehicle 2 at the charging spot is completed, in step S19, the vehicle operation management device 3 instructs the vehicle 2 to travel to the next pick-up location. The vehicle operation management device 3 instructs the vehicle 2 to travel to the next pick-up location by transmitting the travel instruction to the vehicle 2.

When the vehicle 2 receives the travel instruction, in step S20, the vehicle 2 performs automated travel to the next pick-up location according to the travel instruction. After that, the vehicle 2, the vehicle operation management device 3, and the mobile terminal 4 continue the operation of causing the vehicle 2 to travel according to the operation plan. Note that, if the operation plan not including charging of the vehicle 2 is created when the user reserves the use of the vehicle 2, the vehicle 2, the vehicle operation management device 3, and the mobile terminal 4 do not perform the operations in steps S16 to S20 and continue the operation of causing the vehicle 2 to travel according to the operation plan.

Here, the vehicle 2 travels to the charging spot to be charged immediately after the user gets out of the vehicle 2, but the present disclosure is not limited thereto. The timing at which the vehicle 2 is charged may be any timing after the user gets out of the vehicle and before the user gets in the vehicle next. For example, the vehicle 2 may be charged immediately before the user gets in the vehicle 2. Also, the vehicle 2 may be charged before the user first gets in the vehicle 2.

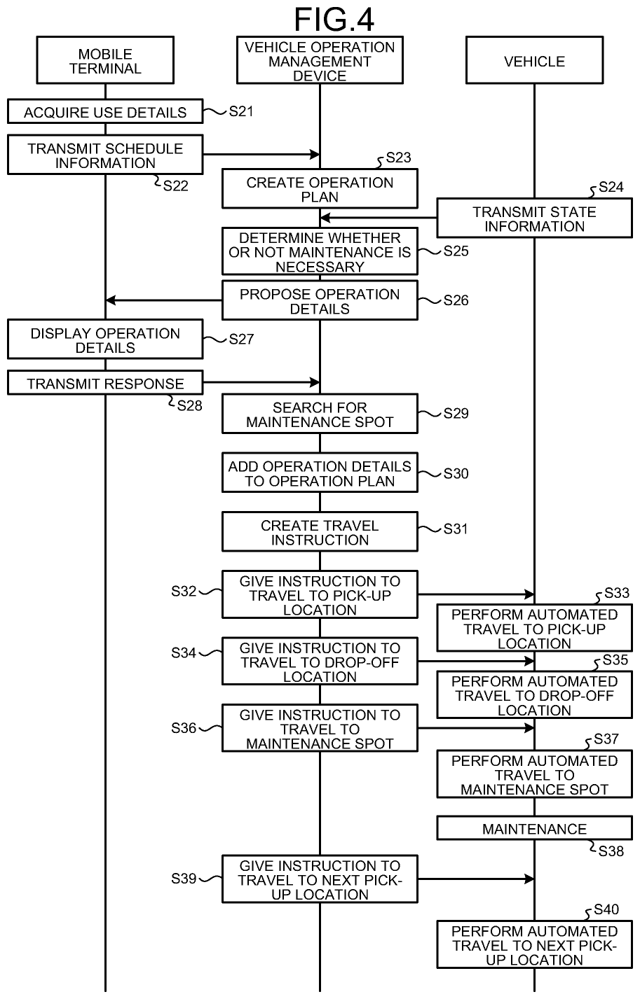

FIG. 4 is a second chart diagram illustrating an example of the operations of the vehicle 2, the vehicle operation management device 3, and the mobile terminal 4 in the first embodiment. The second chart diagram illustrates an operation procedure of the vehicle 2, the vehicle operation management device 3, and the mobile terminal 4 when the vehicle state monitoring unit 32 determines that maintenance of the vehicle 2 is necessary and the operation plan creation unit 31 proposes the operation details including maintenance.

In step S21, the mobile terminal 4 acquires the use details desired by the user, as in step S1 illustrated in FIG. 3. In step S22, the mobile terminal 4 transmits the schedule information to the vehicle operation management device 3, as in step S2 illustrated in FIG. 3. In step S23, the vehicle operation management device 3 creates the operation plan on the basis of the schedule information, as in step S3 illustrated in FIG. 3. In step S24, the vehicle 2 transmits the state information to the vehicle operation management device 3, as in step S4 illustrated in FIG. 3. The vehicle operation management device 3 acquires the state information by receiving the state information transmitted from the vehicle 2.

In step S25, the vehicle operation management device 3 determines whether or not maintenance of the vehicle 2 is necessary on the basis of the state information. Here, it is assumed that the vehicle operation management device 3 determines that maintenance is necessary. Note that, when the vehicle operation management device 3 determines that maintenance is unnecessary, the vehicle operation management device 3 does not perform the operations in steps S26 to S30, and creates the travel instruction according to the operation plan created.

The vehicle operation management device 3 creates the operation details including maintenance of the vehicle 2 during the idle time when the user is not in the vehicle. In step S26, the vehicle operation management device 3 proposes the created operation details to the user. The vehicle operation management device 3 proposes the operation details to the user by transmitting the information of the operation details to the mobile terminal 4. When the mobile terminal 4 receives the information of the operation details, in step S27, the mobile terminal 4 displays the operation details proposed by the vehicle operation management device 3.

The user inputs a response as to whether or not to approve the proposed operation details to the mobile terminal 4. When the response is input to the mobile terminal 4, in step S28, the mobile terminal 4 transmits the response to the vehicle operation management device 3. Here, it is assumed that the user approves the operation details. Note that, when the user does not approve the operation details, the vehicle operation management device 3 transmits a message requesting a change or cancellation of the schedule information to the mobile terminal 4. The mobile terminal 4 displays the message requesting a change or cancellation of the schedule information, and accepts a change or cancellation of the schedule information.

In step S29, the vehicle operation management device 3 searches for a maintenance spot. The vehicle operation management device 3 searches for a maintenance spot around the drop-off location or the next pick-up location, and determines the maintenance spot for performing maintenance of the vehicle 2. In step S30, the vehicle operation management device 3 adds, to the operation plan, the operation details including travel from the drop-off location to the maintenance spot and travel from the maintenance spot to the next pick-up location. The vehicle operation management device 3 thus creates the operation plan including maintenance of the vehicle 2. The above steps S21 to S30 are the operation procedure when the user reserves the use of the vehicle 2.

Note that, when the vehicle operation management device 3 determines that maintenance is unnecessary in step S25, the vehicle operation management device 3 does not perform the operations in steps S26 to S30, and creates the operation plan not including maintenance of the vehicle 2. Also, even when the user does not approve the proposal in step S26, the vehicle operation management device 3 need not request the user to change or cancel the schedule information, if travel can be continued without problems although maintenance is necessary. In this case, the vehicle operation management device 3 does not perform the operations in steps S29 and $30, and creates the operation plan not including maintenance of the vehicle 2.

The following steps S31 to S40 are the operation procedure when the vehicle 2 travels according to the operation plan. In step S31, the vehicle operation management device 3 creates the travel instruction, as in step S11 illustrated in FIG. 3. In step S32, the vehicle operation management device 3 instructs the vehicle 2 to travel to the pick-up location, as in step S12 illustrated in FIG. 3. When the vehicle 2 receives the travel instruction, in step S33, the vehicle 2 performs automated travel to the pick-up location according to the travel instruction.

When the vehicle operation management device 3 confirms that the vehicle 2 has arrived at the pick-up location and that the user has got in the vehicle 2 at the pick-up location, in step S34, the vehicle operation management device 3 instructs the vehicle 2 to travel to the drop-off location, as in step S14 illustrated in FIG. 3. When the vehicle 2 receives the travel instruction, in step S35, the vehicle 2 performs automated travel to the drop-off location according to the travel instruction.

When the vehicle operation management device 3 confirms that the vehicle 2 has arrived at the drop-off location and that the user has gotten out of the vehicle 2, in step S36, the vehicle operation management device 3 instructs the vehicle 2 to travel to the maintenance spot. The vehicle operation management device 3 instructs the vehicle 2 to travel to the maintenance spot by transmitting the travel instruction to the vehicle 2. When the vehicle 2 receives a transmission instruction, in step S37, the vehicle 2 performs automated travel to the maintenance spot according to the travel instruction. When the vehicle 2 arrives at the maintenance spot, in step S38, maintenance is performed on the vehicle 2.

When the vehicle operation management device 3 confirms that the maintenance of the vehicle 2 at the maintenance spot is completed, in step S39, the vehicle operation management device 3 instructs the vehicle 2 to travel to the next pick-up location. The vehicle operation management device 3 instructs the vehicle 2 to travel to the next pick-up location by transmitting the travel instruction to the vehicle 2.

When the vehicle 2 receives the travel instruction, in step S40, the vehicle 2 performs automated travel to the next pick-up location according to the travel instruction. After that, the vehicle 2, the vehicle operation management device 3, and the mobile terminal 4 continue the operation of causing the vehicle 2 to travel according to the operation plan. Note that, if the operation plan not including maintenance of the vehicle 2 is created when the user reserves the use of the vehicle 2, the vehicle 2, the vehicle operation management device 3, and the mobile terminal 4 do not perform the operations in steps S36 to S40 and continue the operation of causing the vehicle 2 to travel according to the operation plan.

Here, the vehicle 2 travels to the maintenance spot to receive the maintenance immediately after the user gets out of the vehicle 2, but the present disclosure is not limited thereto. The timing at which the maintenance of the vehicle 2 is performed may be any timing after the user gets out of the vehicle and before the user gets in the vehicle next. For example, the maintenance of the vehicle 2 may be performed immediately before the user gets in the vehicle 2. Also, the maintenance of the vehicle 2 may be performed before the user first gets in the vehicle 2.

The operation plan creation unit 31 determines both whether or not charging of the vehicle 2 is necessary and whether or not maintenance of the vehicle 2 is necessary. The operation plan creation unit 31 proposes the operation plan including charging when determining that charging is necessary, and proposes the operation plan including maintenance when determining that maintenance is necessary. It is sufficient that the operation plan creation unit 31 determine at least one of whether or not charging is necessity and whether or not maintenance is necessary. When determining whether or not charging is necessary, the operation plan creation unit 31 creates the operation details including charging of the vehicle 2 on the basis of the monitored state information indicating that charging is necessary. When determining whether or not maintenance is necessary, the operation plan creation unit 31 creates the operation details including maintenance of the vehicle 2 on the basis of the monitored state information indicating that maintenance is necessary. It is sufficient that the vehicle 2, the vehicle operation management device 3, and the mobile terminal 4 is able to perform at least one of the operations according to the procedure illustrated in FIG. 3 and the operations according to the procedure illustrated in FIG. 4.

According to the first embodiment, when the user of the vehicle 2 is scheduled to get in the same vehicle 2 again after getting out of the vehicle 2, the operation plan creation unit 31 proposes, to the user, the operation details of the vehicle 2 during the idle time from when the user gets out of the vehicle 2 to when the user gets in the vehicle 2 next. The vehicle state monitoring unit 32 determines whether or not charging is necessary on the basis of the remaining battery level of the vehicle 2, and outputs the monitored state information indicating the result of the determination. Alternatively, the vehicle state monitoring unit 32 determines whether or not maintenance is necessary on the basis of the state of each part of the vehicle 2, and outputs the monitored state information indicating the result of the determination. The operation plan creation unit 31 proposes the operation details created on the basis of the monitored state information to the user, and when the user approves the operation details proposed, the operation plan creation unit 31 creates the operation plan including the operation details proposed. The vehicle operation management device 3 can complete necessary charging or necessary maintenance during the idle time by causing the vehicle 2 to travel according to the operation plan. That is, the vehicle operation management device 3 can efficiently utilize the idle time. The vehicle operation management system 1 and the vehicle operation management device 3 thus have an effect of being capable of efficiently utilizing the idle time during which the user is not in the vehicle 2.

### Second Embodiment

The first embodiment has described the example of creating the operation plan including charging of the vehicle 2 or maintenance of the vehicle 2. A second embodiment will describe an example of creating an operation plan including parking of the vehicle 2 in a parking lot. The configurations of the vehicle 2, the vehicle operation management device 3, and the mobile terminal 4 in the second embodiment are similar to the configurations of the vehicle 2, the vehicle operation management device 3, and the mobile terminal 4 illustrated in FIG. 2. The second embodiment will mainly describe operations different from those of the first embodiment.

If the user of the vehicle 2 is scheduled to get in the same vehicle 2 again after getting out of the vehicle 2, the operation plan creation unit 31 of the vehicle operation management device 3 proposes, to the user, operation details including parking of the vehicle 2 in the parking lot during the idle time from when the user gets out of the vehicle 2 to when the user gets in the vehicle 2 next. Information of the operation details is transferred to the communication unit 30. The communication unit 30 transmits the information of the operation details to the mobile terminal 4. The operation plan creation unit 31 thus proposes, to the user, the operation details including parking of the vehicle 2 in the parking lot. When the user approves the operation details including parking of the vehicle 2 in the parking lot, the operation plan creation unit 31 creates the operation plan including travel from a drop-off location to the parking lot and travel from the parking lot to the next pick-up location.

The operation plan creation unit 31 calculates, on the basis of schedule information, the idle time from when the user gets out of the vehicle 2 until when the user gets in the vehicle 2 next. The operation plan creation unit 31 proposes the operation details that can fit within the calculated idle time to the user. Specifically, the operation plan creation unit 31 creates the operation details such that a sum of a travel time from the drop-off location to the parking lot and a travel time from the parking lot to the next pick-up location becomes less than or equal to the idle time. As a result, the vehicle operation management device 3 can propose the operation details that do not hinder the use of the vehicle 2 by the user.

In the second embodiment, the facility that the facility search unit 33 searches for is the parking lot. The facility search unit 33 searches for the parking lot in the vicinity of the drop-off location or the pick-up location. The operation plan creation unit 31 instructs the facility search unit 33 to search for the parking lot. The facility search unit 33 returns a search result for the parking lot to the operation plan creation unit 31. The operation plan creation unit 31 creates the operation details including parking in the parking lot indicated by the search result. Note that the operation plan creation unit 31 may present, to the user, a plurality of candidates for the parking lot from the search result by the facility search unit 33, and may accept selection of the parking lot from among the plurality of candidates. The operation plan creation unit 31 may also reserve the parking lot when approval for the operation details including parking in the parking lot is obtained.

In the second embodiment, the operation plan creation unit 31 creates the operation plan including parking in the parking lot when the user reserves the use of the vehicle 2. Alternatively, the operation plan creation unit 31 may create the operation plan including parking in the parking lot when the vehicle 2 is in operation according to the operation plan created at the time of the reservation. The operation plan creation unit 31 creates the operation plan including parking in the parking lot by adding operation details regarding parking in the parking lot to the operation plan created at the time of the reservation. In this case, the operation plan creation unit 31 may present, to the user, the parking lot with vacancy among the parking lots indicated by the search result.

The communication unit 40 of the mobile terminal 4 receives information of the operation details including parking in the parking lot from the vehicle operation management device 3. The display unit 42 displays the proposed operation details and a message requesting the user to select whether or not to approve the proposed operation details. When a response as to whether or not to approve the operation details is input to the input unit 41 by the user, the communication unit 40 transmits the input response to the vehicle operation management device 3.

When information about the plurality of candidates for the parking lot is transmitted from the vehicle operation management device 3, the mobile terminal 4 displays the plurality of candidates for the parking lot on the display unit 42. The user operates the input unit 41 to select the parking lot in which the vehicle 2 parks from among the plurality of candidates. In this case, the communication unit 40 transmits the response as to whether or not to approve the operation details and information indicating a selection result by the user to the vehicle operation management device 3.

The vehicle operation management device 3 may present, to the user, the plurality of candidates together with use conditions for each of the plurality of candidates. The use conditions are conditions such as the amount of a parking fee, whether the parking lot is indoor or outdoor, and the presence or absence of benefits. As a result, the vehicle operation management device 3 can allow the user to select the parking lot that meets preferences of the user by referring to the use conditions. Alternatively, the vehicle operation management device 3 may allow the user to set in advance the conditions considered as important for the user such as the fee, whether the parking lot is indoor or outdoor, the benefits, and the like. The vehicle operation management device 3 may determine a candidate to be preferentially recommended to the user on the basis of the conditions considered as important for the user.

In the second embodiment, when the user of the vehicle 2 is scheduled to get in the same vehicle 2 again after getting out of the vehicle 2, the vehicle operation management device 3 proposes parking of the vehicle 2 in the parking lot to the user. If the user approves the operation details proposed, the vehicle operation management device 3 creates the operation plan including parking of the vehicle 2 in the parking lot. The vehicle operation management device 3 causes the vehicle 2 to travel according to the operation plan, thereby being able to cause the vehicle 2 to park in the parking lot while efficiently utilizing the idle time. The user can save the burden of parking the vehicle in the parking lot and the burden of searching for the parking lot. Moreover, the drop-off location and the next pick-up location may be any place where the vehicle 2 can stop in order to perform pick-up or drop-off. This can improve convenience in the use of the vehicle 2.

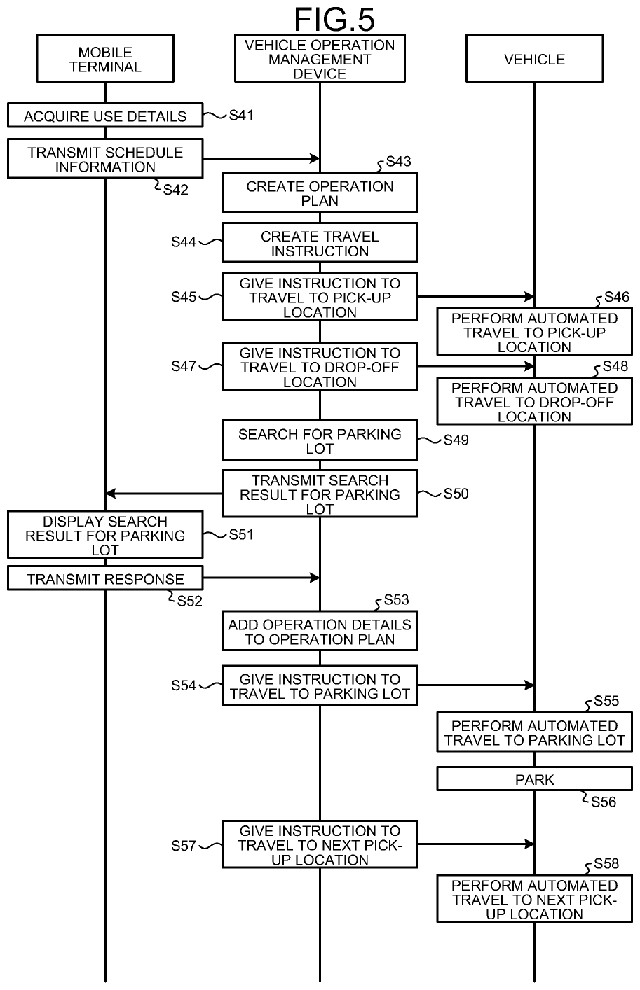

Next, operations of the vehicle 2, the vehicle operation management device 3, and the mobile terminal 4 will be described. FIG. 5 is a chart diagram illustrating an example of the operations of the vehicle 2, the vehicle operation management device 3, and the mobile terminal 4 in the second embodiment.

The user inputs information on desired pick-up location and pick-up time and desired drop-off location and drop-off time to the mobile terminal 4. The mobile terminal 4 thus acquires use details desired by the user in step S41. The mobile terminal 4 creates the schedule information in which the acquired use details are put together. In step S42, the mobile terminal 4 transmits the schedule information to the vehicle operation management device 3. The vehicle operation management device 3 is on standby to receive the schedule information. Upon receiving the schedule information, the vehicle operation management device 3 stores the schedule information received. In step S43, the vehicle operation management device 3 creates the operation plan on the basis of the schedule information.

The above steps S41 to S43 are the operation procedure when the user reserves the use of the vehicle 2. Note that in FIG. 5, the description will be made of an example where the operation plan including parking in the parking lot is created when the vehicle 2 is in operation according to the operation plan created at the time of the reservation. The operation plan creation unit 31 may create the operation plan including parking in the parking lot when the user reserves the use of the vehicle 2.

The following steps S44 to S58 are the operation procedure when the vehicle 2 travels according to the operation plan created at the time of the reservation. In step S44, the vehicle operation management device 3 creates a travel instruction for causing the vehicle 2 to travel according to the operation plan. In step S45, the vehicle operation management device 3 instructs the vehicle 2 to travel to the pick-up location that is the location where the user gets in the vehicle 2. The vehicle operation management device 3 instructs the vehicle 2 to travel to the pick-up location by transmitting the travel instruction to the vehicle 2. When the vehicle 2 receives the travel instruction, in step S46, the vehicle 2 performs automated travel to the pick-up location according to the travel instruction. As with the case of the first embodiment, the vehicle operation management device 3 checks a traveling status of the vehicle 2 as needed on the basis of current location information transmitted from the vehicle 2.

Upon confirming that the vehicle 2 has arrived at the pick-up location, the vehicle operation management device 3 sends a message indicating the arrival of the vehicle 2 to the mobile terminal 4 to notify the user that the vehicle 2 has arrived. After that, upon confirming that the user has got in the vehicle 2 at the pick-up location, in step S47, the vehicle operation management device 3 instructs the vehicle 2 to travel to the drop-off location that is the location where the user gets out of the vehicle 2. The vehicle operation management device 3 instructs the vehicle 2 to travel to the drop-off location by transmitting the travel instruction to the vehicle 2. When the vehicle 2 receives the travel instruction, in step S48, the vehicle 2 performs automated travel to the drop-off location according to the travel instruction.

Upon confirming that the vehicle 2 has arrived at the drop-off location, in step S49, the vehicle operation management device 3 searches for the parking lot. In step S50, the vehicle operation management device 3 transmits the search result for the parking lot to the mobile terminal 4. Here, the vehicle operation management device 3 creates the operation details for parking the vehicle 2 in the parking lot during the idle time when the user is not in the vehicle. The vehicle operation management device 3 proposes the operation details to the user by transmitting the search result for the parking lot to the mobile terminal 4. When the mobile terminal 4 receives the information of the operation details, in step S51, the mobile terminal 4 displays the search result for the parking lot. The user designates the parking lot in which the vehicle 2 parks on the basis of the search result displayed, thereby giving approval to park the vehicle 2 in the designated parking lot.

When information about a plurality of candidates for the parking lot is transmitted from the vehicle operation management device 3, the mobile terminal 4 displays the plurality of candidates for the parking lot on the display unit 42. The user selects the parking lot from among the plurality of candidates to designate the parking lot in which the vehicle 2 parks. In step S52, the mobile terminal 4 transmits a response indicating the parking lot designated by the user to the vehicle operation management device 3. Note that, when the parking lot desired by the user is not in the search result by the vehicle operation management device 3, the mobile terminal 4 may accept a response indicating that the proposal is not approved. If the response indicating that the proposal is not approved is transmitted from the mobile terminal 4, the vehicle operation management device 3 may search for the parking lot again and transmit the search result to the mobile terminal 4.

When the vehicle operation management device 3 receives the response indicating the parking lot designated by the user, in step S53, the vehicle operation management device 3 adds, to the operation plan, the operation details including travel from the drop-off location to the parking lot and travel from the parking lot to the next pick-up location. The vehicle operation management device 3 thus creates the operation plan including parking of the vehicle 2 in the parking lot.

Upon confirming that the user has gotten out of the vehicle 2, in step S54, the vehicle operation management device 3 instructs the vehicle 2 to travel to the parking lot designated by the user. The vehicle operation management device 3 instructs the vehicle 2 to travel to the parking lot by transmitting the travel instruction to the vehicle 2. When the vehicle 2 receives the travel instruction, in step S55, the vehicle 2 performs automated travel to the parking lot according to the travel instruction.

When the vehicle 2 arrives at the parking lot, the vehicle operation management device 3 instructs the vehicle 2 to travel to a vacant parking space. The vehicle 2 moves to the parking space according to the instruction from the vehicle operation management device 3, and stops in the parking space. This completes parking of the vehicle 2 in step S56. If the parking lot is full when the vehicle 2 arrives at the parking lot, the vehicle operation management device 3 instructs the vehicle 2 to wait to enter the parking lot by confirming that the parking lot is full. After that, when a parking space becomes vacant in the parking lot, the vehicle operation management device 3 instructs the vehicle 2 to enter the parking lot and travel to the vacant parking space. Note that, when the parking lot is full, the vehicle operation management device 3 may cause the vehicle 2 to travel around the parking lot to wait to enter the parking lot. Also, if the waiting time to enter the parking lot designated by the user has passed a certain amount of time, the vehicle operation management device 3 may search for a parking lot other than the parking lot designated by the user and change the parking lot in which the vehicle 2 parks. The vehicle operation management device 3 may notify the mobile terminal 4 that the parking lot is full, and may change the parking lot when user's approval is obtained.

At a time corresponding to an estimated arrival time at the next pick-up location minus the time required for moving from the parking lot to the next pick-up location, in step S57, the vehicle operation management device 3 instructs the vehicle 2 to travel to the next pick-up location. The vehicle operation management device 3 instructs the vehicle 2 to travel to the next pick-up location by transmitting the travel instruction to the vehicle 2. When the vehicle 2 receives the travel instruction, in step S58, the vehicle 2 performs automated travel to the next pick-up location according to the travel instruction. After that, the vehicle 2, the vehicle operation management device 3, and the mobile terminal 4 continue the operation of causing the vehicle 2 to travel according to the operation plan.

Note that the timing when the vehicle operation management device 3 searches for the parking lot and transmits the search result to the mobile terminal 4 is not limited to the timing when the vehicle 2 arrives at the drop-off location. The vehicle operation management device 3 may search for the parking lot and transmit the search result to the mobile terminal 4 before the vehicle 2 arrives at the drop-off location. Alternatively, the vehicle operation management device 3 may search for the parking lot and transmit the search result to the mobile terminal 4 after confirming that the user has gotten out of the vehicle 2 at the drop-off location.

According to the second embodiment, the operation plan creation unit 31 proposes, to the user, the operation details including parking in the parking lot during the idle time from when the user gets out of the vehicle 2 until when the user gets in the vehicle 2 next. When user's approval is obtained, the operation plan creation unit 31 creates the operation plan including travel from the drop-off location to the parking lot and travel from the parking lot to the next pick-up location. The vehicle operation management device 3 causes the vehicle 2 to travel according to the operation plan, thereby being able to cause the vehicle 2 to park in the parking lot while efficiently utilizing the idle time. The vehicle operation management system 1 and the vehicle operation management device 3 thus have an effect of being capable of efficiently utilizing the idle time during which the user is not in the vehicle 2.

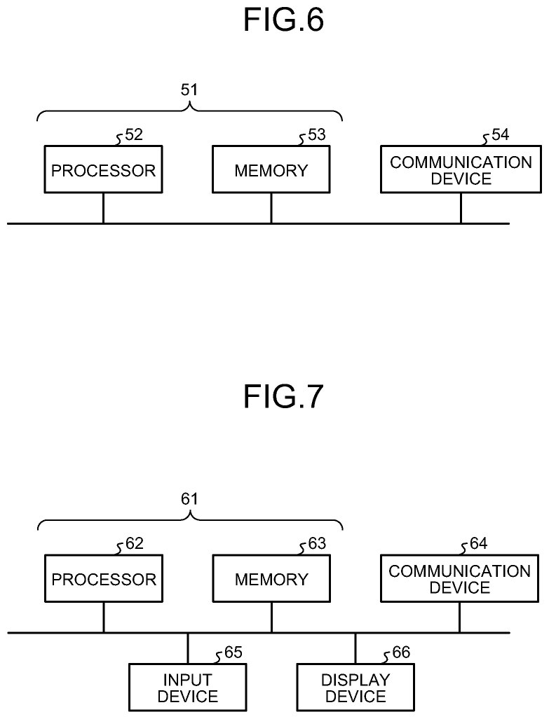

Next, a hardware configuration of the vehicle operation management device 3 according to the first and second embodiments will be described. FIG. 6 is a diagram illustrating an example of the hardware configuration of the vehicle operation management device 3 according to the first and second embodiments. The vehicle operation management device 3 is implemented by a computer system illustrated in FIG. 6. Processing circuitry 51 illustrated in FIG. 6 includes a processor 52 and a memory 53. The processing circuitry 51 is also called control circuitry. The operation plan creation unit 31, the vehicle state monitoring unit 32, the facility search unit 33, and the travel instruction unit 34, which are main units of the vehicle operation management device 3, are implemented by the use of the processing circuitry 51.

The processor 52 is a central processing unit (CPU). The processor 52 may be an arithmetic unit, a microprocessor, a microcomputer, or a digital signal processor (DSP). The memory 53 corresponds to, for example, a non-volatile or volatile semiconductor memory such as a random access memory (RAM), a read only memory (ROM), a flash memory, an erasable programmable read only memory (EPROM), or an electrically erasable programmable read only memory (EEPROM (registered trademark)), a magnetic disk, a flexible disk, an optical disk, a compact disc, a mini disc, a digital versatile disc (DVD), or the like.

The memory 53 stores a vehicle operation management program that is a program for operating as the main units of the vehicle operation management device 3. The processing circuitry 51 can implement the functions of the main units of the vehicle operation management device 3 by the processor 52 reading and executing the vehicle operation management program. In addition, the memory 53 stores data obtained in the course of processing. A communication device 54 communicates with each of the vehicle 2 and the mobile terminal 4. The function of the communication unit 30 is implemented by the use of the communication device 54. The vehicle operation management device 3 may be implemented by a plurality of computer systems. For example, the vehicle operation management device 3 may be implemented by a cloud computer system.

The vehicle operation management program of the first and second embodiments causes the computer system to execute a step of creating the operation plan of the vehicle 2 on the basis of the schedule for getting in and out of the vehicle 2 of the user who wants to ride the vehicle 2, and a step of instructing the vehicle 2 to travel according to the operation plan. In the step of creating the operation plan, if the user of the vehicle 2 is scheduled to get in the same vehicle 2 again after getting out of the vehicle 2, the operation details of the vehicle 2 during the period of time from when the user gets out of the vehicle 2 to when the user gets in the vehicle 2 next are proposed to the user, and the operation plan including the proposed operation details is created.

The vehicle operation management program may be stored in a storage medium that can be read by the computer system. The vehicle operation management device 3 may store, in the memory 53, the vehicle operation management program recorded in the storage medium. The storage medium may be a portable storage medium that is a flexible disk, or may be a flash memory that is a semiconductor memory. The vehicle operation management program may be installed on the computer system from another computer or a server device via a network.

The functions of the operation plan creation unit 31, the vehicle state monitoring unit 32, the facility search unit 33, and the travel instruction unit 34 are implemented by a combination of the processor 52 and software. The functions may be implemented by a combination of the processor 52 and firmware, or may be implemented by a combination of the processor 52, software, and firmware. The software or firmware is described as a program and stored in the memory 53.

The vehicle state acquisition unit 21, the travel instruction acquisition unit 22, and the vehicle control unit 23 of the vehicle 2 are implemented by the computer system illustrated in FIG. 6, as with the vehicle operation management device 3. The vehicle state acquisition unit 21, the travel instruction acquisition unit 22, and the vehicle control unit 23 are implemented by the use of the processing circuitry 51. The functions of the vehicle state acquisition unit 21, the travel instruction acquisition unit 22, and the vehicle control unit 23 are implemented by a combination of the processor 52 and software or the like. The function of the communication unit 20 is implemented by the use of the communication device 54.

Next, a hardware configuration of the mobile terminal 4 according to the first and second embodiments will be described. FIG. 7 is a diagram illustrating an example of the hardware configuration of the mobile terminal 4 according to the first and second embodiments. The mobile terminal 4 is implemented by a computer system, as with the vehicle operation management device 3. The mobile terminal 4 includes processing circuitry 61, a processor 62, a memory 63, and a communication device 64 similar to the processing circuitry 51, the processor 52, the memory 53, and the communication device 54 illustrated in FIG. 6, respectively. The mobile terminal 4 further includes an input device 65 and a display device 66. The control unit 43 illustrated in FIG. 2 is implemented by the use of the processing circuitry 61. The function of the control unit 43 is implemented by a combination of the processor 62 and software or the like.

The input device 65 is used by a user of the computer system to input various types of information. The function of the input unit 41 is implemented by the use of the input device 65. The display device 66 displays various types of information. The function of the display unit 42 is implemented by the use of the display device 66.

The input device 65 and the display device 66 are included in a touch panel. The input device 65 may include, for example, character input means such as a keyboard and/or a pointing device such as a mouse. The display device 66 may include a display, a liquid crystal display panel, or the like.

The configurations illustrated in the above embodiments each illustrate an example of the content of the present disclosure. The configurations of the embodiments can be combined with another known technique. The configurations of the embodiments may be combined together as appropriate. A part of the configurations of the embodiments can be omitted or modified without departing from the scope of the present disclosure.

### REFERENCE SIGNS LIST

1 vehicle operation management system; 2 vehicle; 3 vehicle operation management device; 4 mobile terminal; 20, 30, 40 communication unit; 21 vehicle state acquisition unit; 22 travel instruction acquisition unit; 23 vehicle control unit; 24 sensor unit; 31 operation plan creation unit; 32 vehicle state monitoring unit; 33 facility search unit; 34 travel instruction unit; 41 input unit; 42 display unit; 43 control unit; 51, 61 processing circuitry; 52, 62 processor; 53, 63 memory; 54, 64 communication device; 65 input device; 66 display device.

1. A vehicle operation management device that manages operation of a vehicle, the vehicle operation management device comprising:
processing circuitry
to create an operation plan of the vehicle on the basis of a schedule for getting in and out of the vehicle of a user who wants to ride the vehicle; and
to instruct the vehicle to travel according to the operation plan, wherein
when the user of the vehicle is scheduled to get in the same vehicle again after getting out of the vehicle, the processing circuitry proposes, to the user, operation details of the vehicle during a period of time from when the user gets out of the vehicle to when the user gets in the vehicle next, and creates the operation plan including the operation details proposed.

2. The vehicle operation management device according to claim 1, wherein the processing circuitry monitors a state of the vehicle and output monitored state information indicating a monitoring result, and
proposes the operation details created on the basis of the monitored state information to the user.

3. The vehicle operation management device according to claim 2, wherein the processing circuitry determines whether or not charging is necessary on the basis of a remaining battery level of the vehicle, and outputs the monitored state information indicating a determination result, and
proposes the operation details including charging of the vehicle to the user on the basis of the monitored state information indicating that charging is necessary, and creates the operation plan including travel from a drop-off location to a spot where charging is performed and travel from the spot to a next pick-up location.

4. The vehicle operation management device according to claim 2, wherein the processing circuitry determines whether or not maintenance is necessary on the basis of a state of each part of the vehicle, and outputs the monitored state information indicating a determination result, and
proposes the operation details including maintenance of the vehicle to the user on the basis of the monitored state information indicating that maintenance is necessary, and creates the operation plan including travel from a drop-off location to a spot where maintenance is performed and travel from the spot to a next pick-up location.

5. The vehicle operation management device according to claim 1, wherein the processing circuitry proposes, to the user, the operation details including parking of the vehicle in a parking lot in a period of time from when the user gets out of the vehicle to when the user gets in the vehicle next, and creates the operation plan including travel from a drop-off location to the parking lot and travel from the parking lot to a next pick-up location.

6. The vehicle operation management device according to claim 5, wherein the processing circuitry presents a plurality of candidates for the parking lot to the user, and accepts selection of the parking lot from among the plurality of candidates.

7. The vehicle operation management device according to claim 1, wherein the processing circuitry calculates a time from when the user gets out of the vehicle to when the user gets in the vehicle next, and proposes the operation details that can fit within the calculated time to the user.

8. A vehicle operation management system comprising:
a vehicle controller installed in a vehicle to control travel of the vehicle; and
a vehicle operation management device to manage operation of the vehicle, wherein the vehicle operation management device includes:
processing circuitry
to create an operation plan of the vehicle on the basis of a schedule for getting in and out of the vehicle of a user who wants to ride the vehicle; and
to generate a travel instruction according to the operation plan; and
a communication device to transmit the travel instruction to the vehicle controller, and
when the user of the vehicle is scheduled to get in the same vehicle again after getting out of the vehicle, the processing circuitry proposes, to the user, operation details of the vehicle during a period of time from when the user gets out of the vehicle to when the user gets in the vehicle next, and creates the operation plan including the operation details proposed.

9. The vehicle operation management system according to claim 8, wherein the communication device receives schedule information, which indicates the schedule for getting in and getting out of the vehicle of the user, from a terminal that can communicate with the vehicle operation management device, and
the processing circuitry creates the operation plan on the basis of the schedule information received.

10. A non-transitory computer readable storage medium storing a vehicle operation management program that causes a computer system to execute:
creating an operation plan of the vehicle on the basis of a schedule for getting in and out of the vehicle of a user who wants to ride the vehicle; and
instructing the vehicle to travel according to the operation plan, wherein
in the creating the operation plan, when the user of the vehicle is scheduled to get in the same vehicle again after getting out of the vehicle, operation details of the vehicle during a period of time from when the user gets out of the vehicle to when the user gets in the vehicle next is proposed to the user, and the operation plan including the operation details proposed is created.

11. (canceled)

12. The vehicle operation management device according to claim 2, wherein the processing circuitry calculates a time from when the user gets out of the vehicle to when the user gets in the vehicle next, and proposes the operation details that can fit within the calculated time to the user.

13. The vehicle operation management device according to claim 3, wherein the processing circuitry calculates a time from when the user gets out of the vehicle to when the user gets in the vehicle next, and proposes the operation details that can fit within the calculated time to the user.

14. The vehicle operation management device according to claim 4, wherein the processing circuitry calculates a time from when the user gets out of the vehicle to when the user gets in the vehicle next, and proposes the operation details that can fit within the calculated time to the user.

15. The vehicle operation management device according to claim 5, wherein the processing circuitry calculates a time from when the user gets out of the vehicle to when the user gets in the vehicle next, and proposes the operation details that can fit within the calculated time to the user.

16. The vehicle operation management device according to claim 6, wherein the processing circuitry calculates a time from when the user gets out of the vehicle to when the user gets in the vehicle next, and proposes the operation details that can fit within the calculated time to the user.
